(19) United States
(12) Patent Application Publication
(10) Pub. No.: US 2018/0057755 A1
(43) Pub. Date: Mar. 1, 2018

(54) WAVE MODES FOR THE MICROWAVE INDUCED CONVERSION OF COAL

(71) Applicants: H Quest Partners, LP, Pittsburgh, PA (US); Battelle Memorial Institute, Richland, WA (US)

(72) Inventors: George L. Skoptsov, Pittsburgh, PA (US); James J. Strohm, Allison Park, PA (US); Benjamin Q. Roberts, Richland, WA (US)

(21) Appl. No.: 15/715,265

(22) Filed: Sep. 26, 2017

Related U.S. Application Data
(62) Division of application No. 14/881,991, filed on Oct. 13, 2015.

(51) Int. Cl. C10G 1/06; B01J 19/12; B01J 19/08

(52) U.S. Cl. CPC C10G 1/06; B01J 19/126; B01J 19/088; B01J 2219/0894; B01J 2219/1215; B01J 2219/129; B01J 2219/0879

(57) ABSTRACT

A system for converting hydrocarbon materials into a product includes a hydrocarbon feedstock source, a process gas source, an energy generator, and a cylindrical reaction chamber. The reaction chamber has a conductive inner surface that forms a resonant cavity. The resonant cavity is configured to support a standing TM010 electromagnetic wave. The reaction chamber is also configured to receive feedstock from the feedstock source, process gas from the process gas source, and convert the feedstock into a product stream in the presence of the TM010 electromagnetic wave.

### CROSS-REFERENCE TO RELATED APPLICATIONS

This application claims priority to, and is a divisional application of U.S. patent application Ser. No. 14/881,991, filed Oct. 13, 2015, the disclosure of which is incorporated by reference herein in its entirety.

### BACKGROUND

Because of the world's increasing demand for petroleum products, it has been desirable to find alternative hydrocarbon feedstocks for fuel. For example, it is known to convert coal to liquid fuels using a family of processes known as coal liquefaction. Such processes are disclosed in, for example, U.S. Pat. No. 4,487,683, the disclosure of which is fully incorporated herein by reference. It is also known to upgrade liquid hydrocarbon to fuel-quality products. Such processes are disclosed in, for example, U.S. Pat. No. 7,022,505, the disclosure of which is fully incorporated herein by reference.

Many current liquefaction and hydrocarbon upgrading processes are generally high-temperature/high-pressure processes to enable liquefaction reactions and hydrogen transfer from the hydrogen donor to obtain significant product yield and quality, and thus require significant energy consumption. Existing upgrading processes also lead to high rates of CO₂ emissions, and fresh water consumption. Such processes, thus, have adverse environmental consequences due to high input energy requirements, and often are practically and/or economically unable to meet the scale required for commercial production. The existing systems are frequently inefficient in that the power consumption required by the system negates the benefits because of the low quality and quantity of oil produced.

One method that offers the potential to process hydrocarbon fuels at lower environmental costs than existing commercial systems utilizes plasma processing. In plasma processing, hydrocarbons are fed into a reaction chamber in which they are ionized to form plasma, for example by exposure to a high intensity field. In the plasma state the constituents of the feed material are dissociated and may either be extracted separately, recombined or reacted with additional feed materials, depending on the required output product. Electromagnetic-induced plasmas, in particular, offer the potential for highly efficient cracking of both gas and liquid feed materials due to superior energy coupling between energy source, plasma and feedstock. Such plasmas have been shown to have a catalytic effect, as a result of coupling between the electromagnetic, particularly microwave, field and the feed material, that increases the rate of reaction, which in turn reduces the time for which the feed material must be maintained in the plasma state, i.e. the residency time.

It is, however, difficult to scale up reaction chambers that use microwaves generated for commercial plasma operations, and many current liquefaction and hydrocarbon upgrading processes are practically and/or economically unable to meet the scale required for commercial production due to design constraints leading to scalability issues. Ideally, such a process would be highly flexible in that it should readily admit to operation on small, medium, and large commercial scale.

Accordingly, improved systems for converting and upgrading hydrocarbon fuel products are needed. This document describes methods and systems that are directed to the problems described above.

### SUMMARY

In an embodiment, a system for converting hydrocarbon materials into a product may include one or more hydrocarbon feedstock sources; one or more process gas sources; one or more energy generators; and a cylindrical reaction chamber comprising a conductive inner surface to form a resonant cavity, the resonant cavity configured to support a standing TM010 electromagnetic wave therein. The reaction chamber may also be configured to receive feedstock from one or more of the hydrocarbon feedstock sources and process gas from one or more of the process gas sources and, in the presence of the TM010 electromagnetic wave, convert the feedstock into a product stream. The one or energy generators may be a microwave generator. The resonant frequency of the TM010 electromagnetic wave may be 915 MHz, 434 MHz, 40.6 MHz, 27, MHz, 13.56 MHz, or 2.45 GHz.

In at least one embodiment, the reaction chamber may be configured to direct the flow of the feedstock and the process gas through at least one node of the TM010 electromagnetic wave to form a plasma within the reaction chamber and cause the feedstock and process gas to react and form into the product stream. The reaction chamber may also include a reaction tube to direct the flow of the feedstock and the process gas through at least one node of the TM010 electromagnetic wave. In an embodiment, the reaction tube may be arranged within the reaction chamber to align the axis of the reaction tube with the axis of the TM010 electromagnetic wave.

Additionally and/or optionally, the reaction chamber may include at least two openings to direct the flow of the feedstock and the process gas through at least one node of the TM010 electromagnetic wave

In some embodiments, the system may also include a waveguide comprising a housing having a first end portion configured to be connected to at least one of the one or more energy generators. The waveguide may be configured to launch the TM010 electromagnetic wave within the resonant cavity.

In an embodiment, a diameter of the resonant cavity is about 2 cm to 9.5 cm, and a length of the resonant cavity is about 4.5 cm to 2 meters.

In certain embodiment, the product stream may include at least one oil product. The API of the oil product may be more than 8 and the aromaticity of the oil product is less than 55%.

In certain embodiments, the reaction chamber may further be configured to receive a continuous feed of the feedstock from one or more of the hydrocarbon feedstock sources. In at least one embodiment, the continuous feed of the feedstock may be dispersed within the reaction chamber to promote the formation a plasma within the reaction chamber and cause the feedstock and process gas to react and form into the product stream within at least one node of the TM010 electromagnetic wave.

### BRIEF DESCRIPTION OF THE DRAWINGS

FIG. 1 is a flow schematic of a system for processing hydrocarbons.

FIG. 2 is a mode chart for right circular cylindrical cavity.

FIG. 3 is an illustration of an example of a TM010 resonant reaction chamber that may be used with the disclosed system.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

This document describes systems for processing hydrocarbon materials, such as through liquefaction or through upgrading into a fuel-grade material or intermediate material. The processing may include altering the arrangement of carbon and hydrogen atoms and/or removal of heteroatoms such as sulphur, nitrogen, and oxygen. The examples described below will use coal as an example of the material to be processed. However, the system may be used to process various naturally occurring hydrocarbon-based materials such as fossil hydrocarbons and biomass. Examples of fossil hydrocarbons may include among other things, coal, bitumen, oil sands, tar sands, oil shale, petroleum resids, asphaltenes, pre-asphaltenes or other vitrinite and kerogen-containing materials and fractions or derivatives thereof. In some embodiments, the feedstock may be comprised of solid or partially solid, gaseous and/or liquid materials. The system may also be used to process hydrocarbon gases such as natural gas, methane, propane, butane, ethane, ethylene, and other hydrocarbon compounds, and their mixtures, which are normally in a gaseous state of matter at room temperature and atmospheric pressure. The system also may be used to process other hydrocarbon-based materials such as municipal waste, sludge, or other carbon-rich materials.

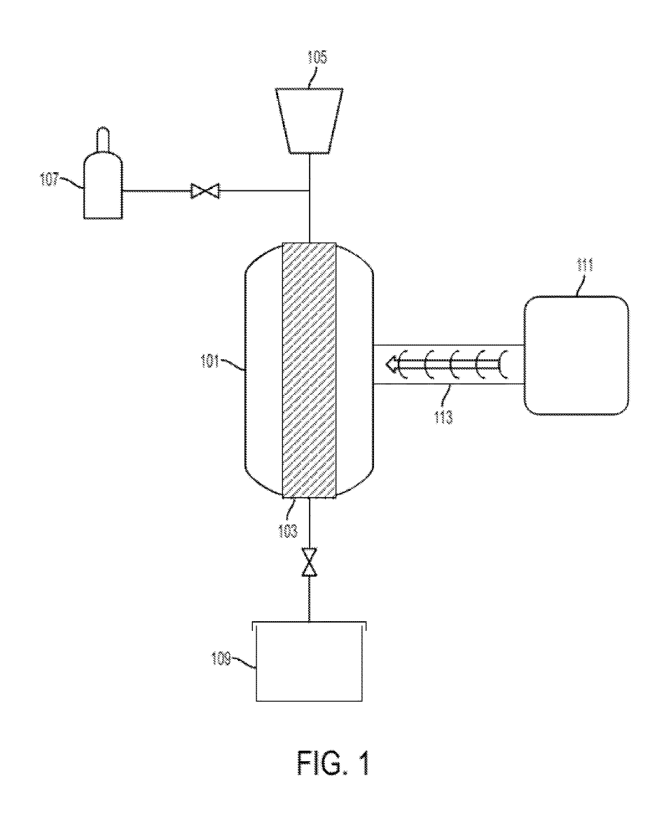

FIG. 1 illustrates an example of a system for processing coal or other hydrocarbons. A reaction chamber 101 may be used to convert the feedstock into a liquid fuel, or upgrade the feedstock to a fuel product or intermediate product. The reaction chamber may receive feedstock from one or more hydrocarbon feedstock sources 103, such as a coal hopper. The feedstock may be in powder form (such as coal particles), optionally entrained in a gas (e.g., a mixture of natural gas, hydrogen or argon). In certain embodiments, the feedstock may be in vapor phase, when process gas temperature is higher than the boiling point of the feedstock or feedstock fractions and compounds. It may also be in liquid form as an atomized spray, droplets, emulsions, or aerosols entrained in a process gas. The hydrocarbon feedstock may be supplemented with any suitable catalyst or supplemental material, such as various metals, metal oxide salts or powders, carbon material, or other metallic materials or organometallic species which may enhance the reaction caused by microwave radiation as described below. Examples of catalysts may include materials containing iron, nickel, cobalt, molybdenum, carbon, copper, silica, oxygen, or other materials or combinations of any of these materials. The feedstock may be delivered via any suitable means, such as in powdered form and forced into the system by an injection device 118.

The reaction may occur at relatively low bulk process temperatures and pressures. For example, conversion and upgrading may occur with average reaction chamber pressures between 0.1 and 10 atmospheres, temperatures between −182° C. and 200° C. (the average reaction chamber temperature) and between 200° C. and 1600° C. (localized plasma temperature), and residence times between 0.001 and 600 seconds. Other parameters are possible.

A flow of process gas from a process gas source 107 may be injected or otherwise delivered to the hydrocarbon feedstock before, after, or as it enters the reaction chamber 101. The process gas will react with the feedstock in the reaction chamber to yield the final product. The process gas may include, for example, hydrogen, methane or other compounds of hydrogen and carbon. Multiple process gas sources 107 may be available so that a combination of process gases is directed into the reaction chamber. An example process gas combination includes an inert gas such as argon, helium, krypton, neon or xenon. The process gas also may include carbon monoxide (CO), carbon dioxide (CO₂), water vapor (H₂O), methane (CH₄), hydrocarbon gases (CₙH₂ₙ₊₂, CₙHₙ, CₙH_{n,} where n=2 through 6), and hydrogen (H₂) gases.

The system includes an energy source 111, along with a waveguide 113 that directs electromagnetic radiation (or other forms of energy) from the energy source 111 into the chamber 101. Examples of an energy source 111 may include, without limitation, a microwave generator, a magnetron, a solid state source, or any other suitable device that utilizes electrical current and/or electrical energy pulse to generate an electromagnetic wave. In an embodiment, the frequency of the electromagnetic wave generated by the energy source 111 may be between about 6 MHz to 24.25 GHz. In some embodiments, the frequency of the electromagnetic wave may be 2.45 GHz. In certain other embodiments, the frequency of the electromagnetic wave may be at least one of the following—915 MHz, 434 MHz, 40.6 MHz, 27 MHz, and 13.56 MHz.

Examples of a waveguide 113 may include, without limitation, a waveguide surfatron, a surfatron, a surfaguide, antenna, and a coaxial port. In certain embodiments, the electromagnetic radiation may be directly induced (without a waveguide) into the reaction chamber 101, through the chamber walls. The waveguide 113 may be circular, rectangular, elliptical, or any other suitable shape. In some embodiments, the waveguide may include flanges to contain the electromagnetic radiation within the system.

In certain embodiments, the reaction chamber may be a “continuous-flow” type of reaction chamber, wherein reactants (including feedstock, catalyst and/or process gas) are continuously fed through the reaction zone and continuously emerge as products and/or waste in a flowing stream (continuous conversion process). The feedstock material may be dispersed slightly to promote the generation of dielectric discharges and plasmas.

The waveguide and/or the reaction chamber may be multi-mode or single-mode, based on the geometry of the cavity. A multi-mode reaction chamber leads to the generation and propagation of electromagnetic waves that include multiple wave propagation modes and variable and/or non-uniform electric field intensities. Examples of a multi-mode reaction chamber may include a household microwave oven. A single-mode reaction chamber leads to the generation and propagation of electromagnetic waves that include a standing wave formed from an incident and a reflected wave in a resonant cavity. A standing wave is a wave that resonates within the specified configuration that creates an electromagnetic field distribution. In coal liquefaction process, a standing wave may be used to establish predictable and consistent patterns of the electromagnetic field strength, location, and/or properties. However, it places constraints on the geometry and size of the system and the reaction chamber. In multimode, in contrast, the entire reaction chamber is irradiated substantially homogeneously, which enables, for example, greater reaction volumes. Examples of a larger single-mode reaction chambers are discussed below.

The reaction chamber 101 may be made of a conductive material that may confine the electromagnetic radiation within the chamber. Examples of materials may include, without limitation, stainless steel, carbon steel, steel alloys, aluminum alloys, copper, tin, nickel, nickel alloys, brass, titanium, or any other conductive material. In some embodiments, the reaction chamber 101 may be made of a non-conductive material with a conductive material coating on the interior of the chamber. Examples of conductive material coating may include, without limitation, inert dielectric material, gold, silver, stainless steel, carbon steel, steel alloys, aluminum alloys, copper, tin, nickel, nickel alloys, brass, titanium, Teflon, silicon, silica, alumina, carbon, graphite, or any other conductive material.

The reaction chamber may also include a reaction tube 103 made of quartz, borosilicate glass, alumina, sapphire, or other suitable dielectric material that enhances reaction of materials within the tube and/or when microwave radiation is directed into the chamber 101, and that is transparent to the electromagnetic radiation. In certain embodiments, the reaction tube 103 may be in physical connection with the waveguide 113. In certain embodiments, the reaction tube 103 may pass through the waveguide 113.

When provided at a suitable intensity and time duration, the electromagnetic radiation is launched within the chamber 101, and causes a plasma to form within the reaction tube 103. The reaction may include processes such as chemical vapor deposition, gasification, thermal pyrolysis, radical reaction chemistry, ion reactions, microwave-enhanced reactions, and/or ion sputtering. The result of the reaction may be a product stream comprising a plurality of products characterized by different chemical and/or physical properties than the original reactant, as a result of rearrangement of atoms within the molecules, change in number of atoms per molecule, or number of molecules present, that may be delivered to one or more product storage vessels 109. The process is described in related patent publication number US 2013/0213795, filed by Strohm et al., which is hereby incorporated by reference in its entirety.

To date, processes such as those shown in FIG. 1 have been applied to small, research-scale systems in which the reaction tube 103 has a diameter of about 1 inch, and passes through a rectangular waveguide 113 with dimensions of about 2.84″×1.34″. In an alternate embodiment, a reaction tube having a diameter of 2 inches may pass through a rectangular waveguide 113 with dimensions of about 3.40″×1.70″. Typically, these conventional dimensions and shape of the cavity and/or waveguide result in the launching and propagation of a TE10 mode, standing electromagnetic wave inside the reaction chamber along the primary axis of the reaction chamber.

However, the prior art, propagation of a TE10 electromagnetic wave may hinder the scaling of the system because of the size limitations of a rectangular TE10 waveguide needed to generate TE10 electromagnetic waves. Alternate reaction vessels are needed to enable larger diameter and/or length of the reaction zone for higher process throughputs. The application of TE10 electromagnetic waves may also produce lower oil quality (as shown in the experimental results discussed below).

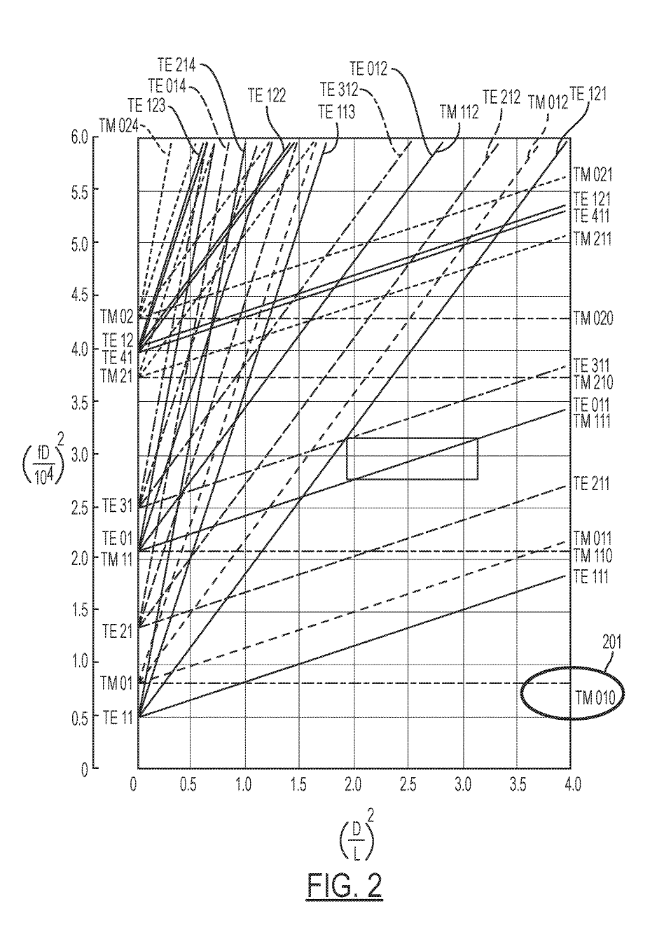

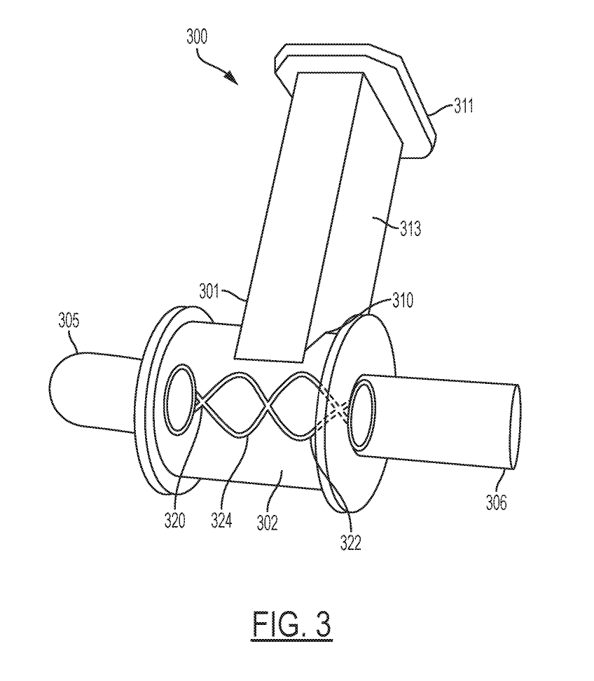

To address this problem, an alternate embodiment, as shown in FIG. 3, uses a cylindrical reaction chamber that has a resonant frequency in the TM010 mode. A cylindrical reaction chamber including a resonant cavity configured to generate and maintain resonant TM010 waves may offer many advantages. For example, an advantage of the TM010 mode is that the maximum of the fields are in the center, and the electric field intensity is uniform along the longitudinal axis of the reaction chamber. This may be useful in an embodiment in which the feedstock passes directly through the reaction chamber, with no reaction tube, thus allowing for a larger reaction volume. The electromagnetic field distribution in a TM010 wave is radially symmetric. More importantly, the axial field distribution is constant over the whole length of the cavity when no perturbations are present in the cavity. Thus, the reaction may be contained within regions of desired electromagnetic field strength. Furthermore, a TM010 reaction chamber may allow for proper containment of the microwave radiations within the reaction chamber. Finally, as shown in FIG. 2, the resonant frequency 201 of a TM010 chamber is independent of the length, thus allowing for easier scale up of the length of the reaction chamber.

As shown in FIG. 3, in an embodiment, a reaction chamber 301 for processing hydrocarbon feedstock may include a resonant cavity 302. The chamber, in certain embodiments, may have an elongated a reaction tube (not shown here) made of a low loss dielectric material disposed in the central portion of the chamber. In an alternate embodiment, the reaction tube may not be present. The walls of the resonant cavity 302 are, in one embodiment, formed from a substantially conductive material, or may be lined with a layer of a conductive material (as discussed above). This layer of conductive material, in one embodiment, may have a higher conductivity than the material used for the walls of the resonant cavity 302. In general, the conductivity of the material determines how efficiently that material will reflect microwaves. The use of a highly conductive inner surface allows efficient reflection of the microwave energy by the walls of the cavity to help create and stabilize a TM resonant mode. In an embodiment, the diameter of the resonant cavity may be between 1 cm to 9.5 cm, and the length of the resonant cavity may be between about 4.5 cm to 2 meters. For example, in an embodiment the diameter of the resonant cavity is about 9.0 cm and the length is about 16.5 cm.

The reaction chamber 301 may have a diameter between 1.0 cm and 9.3 cm, for example, 1.0 cm, 2.0 cm, 4.45 cm, 9.3 cm, and/or any other diameter value within these ranges, but not larger than the cavity 302 diameter. The reaction chamber 301 may have a length between 2.0 cm and 4 meters, but not larger than the cavity 302 diameter. As discussed above, the resonant frequency of the TM010 mode depends on the diameter of the chamber. Thus, the diameter may be selected to produce TM010 resonance mode microwave radiations of a desired frequency. For a smaller diameter, a cylindrical dielectric reaction tube may be inserted into the reaction chamber 301. The length of the reaction chamber 301 here may mean the total distance through which the feedstock material flows. The length may be adjusted to match and/or vary process variables that are independent of the microwave system, such as residence times, degree of reaction, and/or linear velocity. In certain embodiments, the length of the reaction chamber may be between 3 inches to 25 feet, or another size within or outside of this range.

Over its length, the reaction chamber 301 may be surrounded by at least one coaxial microwave generator 311. In an embodiment, the microwaves may be launched through the chamber walls. In another embodiment, the chamber may include a slot 310 to allow microwave radiation to enter the chamber from a waveguide 313. Examples of a waveguide may include a waveguide surfatron, a surfatron, or a surfaguide. The waveguide 313 may be formed from a conductive material optimized for the transmission of microwave energy of the desired frequency. Example materials include metals with high conductivity such as copper, aluminum, zinc, brass, iron, steel and alloys and combinations thereof. Optionally, the waveguide 313 may be plated or otherwise coated with, or contain particles of, an additional conductive material such as gold or silver. In the embodiment shown a rectangular waveguide 313 is used, however, other shapes are within the scope of this disclosure. The physics of such waveguides is well understood and need not be discussed in detail in this specification. The slot 310 may be formed at any location along the body of the reaction chamber 301, and positioned to launch the microwaves along an axis parallel to the length of the reaction chamber to allow the incoming microwave radiation to have the proper orientation to form the transverse magnetic resonance mode (TM010 mode). In an embodiment, the slot may be rectangular, circular or any other suitable shape. The microwave generator 311 may have to be tuned in order to produce microwaves having the appropriate power to produce the desired TM010 resonance mode.

The apparatus 300 may be configured to operate as a single mode (TM010) cavity. A resonant mode 320 may be established within the reaction chamber, with one or more nodes (322, 324, . . . ) where the electric field component of the microwave pattern is at a maximum. These nodes are regions of high-energy transfer from the microwave pattern to the feedstock material. In certain embodiments, the nodes lie along one or more node axes parallel to the length of the cavity. In an embodiment, the TM010 standing wave nodes lie on a single node axis that passes down the center line of the cavity.

In one embodiment, at least two openings 305 and 306 may be formed in the body of the chamber, as depicted in FIG. 3, to allow entrance of feedstock material from a feedstock source, and egress of oil product to product storage vessels. The slots 305 and 306 may be oriented such that the feedstock may pass through at least a portion of the reaction chamber having desired electromagnetic field strength, for processing. For example, the feedstock may be passed through the reaction chamber 301 such that the material passes through the regions of high electric field strength 322 and 324 (the nodes along the center). The high energy imparted in these regions may cause the formation of microwave plasma thus converting or upgrading the feedstock into hydrocarbon fuel with desired oil quality. The openings 305 and 306 may also be configured to allow process gas to pass into the chamber, from process gas source.

As discussed above, the reaction chamber 301 may be configured to operate as a continuous-flow type of chamber, wherein the continuous flow of the feedstock is slightly dispersed to further promote the generation of microwave plasma in the node areas of the standing wave, and for the continuous formation of the desired high quality oil product.

The transmission of microwave energy maybe continuous or pulsed.

In an embodiment, the resonance mode and the geometry of nodes may be perturbed by the presence of feedstock and other material in the reaction chamber. A reaction tube may thus be positioned within the reaction chamber to align with perturbed axis of the resonant nodes to achieve the desired electromagnetic field strength for the conversion of feedstock into higher quality oil (compared to TE10 mode).

The process according to the above discussed disclosure allows for high throughput conversion of hydrocarbon feedstock into oil products with high yields and high quality. More particularly, the oil products have higher API specific gravity (density of oil) and lower aromaticity compared to oil products formed from prior art methods. In an embodiment, the API of the oil product formed is at least 8. In another embodiment, the aromaticity of the oil product formed is less than 58%.

Tables 1 and 2 present the comparison of oil product properties obtained from a conventional reaction chamber (generates TE10 mode electromagnetic waves) and a reaction chamber according to the current disclosure (generates TM010 mode electromagnetic waves). For comparison purposes, the conversion of feedstock was effected in a Universal Waveguide Applicator (WR284) for generation of TE10 mode electromagnetic waves and a Gerling Plasma Applicator or generation of TM010 mode electromagnetic waves, both at a frequency of 2.45 GHz.

TABLE 1
Product Quality

| | Run ID | | | | | |
|---|---|---|---|---|---|---|
| | ILL-R1 | ILL-R2 | ILL-R3 | ILL-R4 | ILL-R5 | ILL-R6 |
| Approx. API | −9.5 | −6.3 | 3.3 | 8.6 | 9.3 | 10.6 |
| Gravity of | | | | | | |
| Total Liq | | | | | | |

% C based on ¹³C-NMR

| | | | | | | |
|---|---|---|---|---|---|---|
| Aromatic | 87.04 | 79.45 | 71.00 | 57.74 | 49.37 | n.d. |
| Carbon | | | | | | |
| Bridgehead | 8.27 | 6.08 | 6.72 | 4.29 | 4.25 | n.d. |
| Peripheral | 54.54 | 47.64 | 38.96 | 21.16 | 19.50 | n.d. |
| Unsubstituted | | | | | | |
| Aliphatic | 12.96 | 20.55 | 29.00 | 39.79 | 49.38 | n.d. |
| Carbon | | | | | | |
| Naphthenic | 0.00 | 11.33 | 12.20 | 18.33 | 20.70 | n.d. |
| Carbon | | | | | | |
| Paraffinic | 12.96 | 9.15 | 17.00 | 16.87 | 26.19 | n.d. |
| Carbon | | | | | | |
| Methine | 0.36 | 1.34 | 1.06 | 3.38 | 4.79 | n.d. |
| Carbon | | | | | | |
| Methylene | 6.34 | 10.00 | 17.15 | 24.82 | 33.41 | n.d. |
| Carbon | | | | | | |
| Methyl Carbon | 6.22 | 9.20 | 10.80 | 7.88 | 9.11 | n.d. |
| Phenolic | 3.46 | 3.27 | 3.52 | 3.21 | 2.73 | n.d. |
| Carbon | | | | | | |

TABLE 2

| | TE10 Cavity | | | TM010 Cavity | | |
|---|---|---|---|---|---|---|
| | | | CH4 Co- | | | CH4 Co- |
| | H2 Co-Feed | | feed | H2 Co-Feed | | Feed |
| WL ™ of Illinois #6 | ILL-R1 | ILL-R2 | ILL-R3 | ILL-R4 | ILL-R5 | ILL-R6 |
| WL ™ CONDITIONS | | | | | | |
| Applied Microwave Energy | 28.83 | 17.98 | 13.44 | 8.73 | 10.97 | 3.24 |
| (Wh/g_{coal, a.r}) | | | | | | |
| PRODUCT YIELDS | | | | | | |
| Oil Yield | 73.0 | 35.3 | 35.9 | 35.5 | 51.1 | 43.92 |
| Preasphaltene Yield | 5.31 | 8.7 | 1.2 | 1.80 | 2.78 | 1.21 |
| Liquid Yield (wt %, daf) | 104.22 | 58.51 | 49.4 | 49.65 | 71.73 | 60.03 |
| API of Oil Product | −9.5 | −6.3 | 3.3 | 8.6 | 9.3 | 10.6 |
| MICROWAVE PARAMETERS | | | | | | |
| Applied Power, W | 850 | 800 | 800 | 850 | 800 | 850 |
| Applicator | TE10 | TE10 | TE10 | TM010 | TM010 | TM010 |
| Power per unit reaction zone | 77.3 | 72.8 | 72.8 | 16.4 | 15.4 | 16.4 |
| volume | | | | | | |
| Cavity Volume | 224.6 | 224.6 | 224.6 | 1050.3 | 1050.3 | 1050.3 |
| Cavity Shape | Rectangular | Rectangular | Rectangular | Cylindrical | Cylindrical | Cylindrical |
| Cavity Dimensions (W × H × L or | 7.2 × 4.3 × | 7.2 × 4.3 × | 7.2 × 4.3 × | 9.0 × | 9.0 × | 9.0 × |
| D × L) (in cm.) | 7.2 | 7.2 | 7.2 | 16.5 | 16.5 | 16.5 |
| Power per unit cavity volume | 3.78 | 3.56 | 3.56 | 0.81 | 0.76 | 0.81 |

As shown in Tables 1 and 2, the APIs of the oil product obtained from a TM010 reaction chamber, in accordance with the current disclosure, are 8.6, 9.3, and 10.6 respectfully, which is significantly higher than that of the prior art oil product. Furthermore, the aromaticity of the oil product obtained from a TM010 reaction chamber, in accordance with the current disclosure, are around 50%, much less than that of the prior art oil product.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method for converting hydrocarbon materials into a product, comprising:
receiving, in a cylindrical reaction chamber, a hydrocarbon feedstock, wherein the cylindrical reaction chamber comprises a conductive inner surface to form a resonant cavity;
receiving, in the first reaction chamber, a process gas;
forming, in the cylindrical reaction chamber, a standing TM010 electromagnetic wave in the presence of microwave energy from a microwave generator; and
converting, in the cylindrical reaction chamber, the hydrocarbon feedstock into a product stream in the presence of the TM010 electromagnetic wave, wherein the product stream comprises at least one oil product that has an API gravity of at least 8.

2. The method of claim 1, wherein the at least one oil product has an aromaticity of less than 55%.

3. The method of claim 1, wherein converting the hydrocarbon feedstock into the product stream comprises directing the flow of the hydrocarbon feedstock and the process gas through at least one node of the TM010 electromagnetic wave to form a plasma within the reaction chamber and converting the hydrocarbon feedstock into the product stream in presence of the plasma to promote conversion of the hydrocarbon feedstock.

4. The method of claim 1, wherein forming the standing TM010 electromagnetic wave comprises forming a standing TM010 electromagnetic wave that has a resonant frequency of 915 MHz, 434 MHz, 40.6 MHz, 27, MHz, 13.56 MHz, or 2.45 GHz.

5. The method of claim 1, wherein receiving the hydrocarbon feedstock comprises receiving a continuous feed of the hydrocarbon feedstock.

6. The method of claim 5, further comprising dispersing the continuous feed of the hydrocarbon feedstock within the cylindrical reaction chamber to promote formation of a plasma that causes the feedstock and the process gas to react and form into the product stream.

7. The method of claim 5, wherein the residence time of the hydrocarbon feedstock in the reaction chamber is about 0.001 seconds to about 600 seconds.

8. The method of claim 5, wherein converting the hydrocarbon feedstock into the product stream comprises flowing the hydrocarbon feedstock for a distance of about 2 centimeters to about 762 centimeters.

9. The method of claim 8, wherein converting the hydrocarbon feedstock into the product stream comprises flowing the hydrocarbon feedstock for a distance of about 4 centimeters to about 400 centimeters.

10. The method of claim 1, further comprising entraining the hydrocarbon feedstock in the process gas.

11. The method of claim 10, wherein entraining the hydrocarbon feedstock comprises entraining the hydrocarbon feedstock in a vapor phase, as an atomized spray, as droplets, as emulsions, or as aerosols.

12. The method of claim 1, wherein forming the standing TM010 electromagnetic wave comprises providing a power per unit reaction chamber volume of 15.4 or 16.4.

13. An oil product prepared by a process comprising the steps of:
receiving, in a cylindrical reaction chamber, a hydrocarbon feedstock, wherein the cylindrical reaction chamber comprises a conductive inner surface to form a resonant cavity;
receiving, in the first reaction chamber, a process gas;
forming, in the cylindrical reaction chamber, a standing TM010 electromagnetic wave in the presence of microwave energy from a microwave generator; and
converting, in the cylindrical reaction chamber, the hydrocarbon feedstock into a product stream in the presence of the TM010 electromagnetic wave;
wherein the oil product that has an API greater than 8.

14. The method of claim 13, wherein the oil product also has an aromaticity of less than 55%.
